(19) United States
(12) Patent Application Publication
(10) Pub. No.: US 2026/0346826 A1
(43) Pub. Date: Nov. 5, 2026

(54) ELECTRIC BRAKING DEVICE

(71) Applicant: ADVICS CO., LTD., Kariya-shi, Aichi-ken (JP)

(72) Inventor: Kenta KAKIZOE, Kariya-shi, Aichi-ken (JP)

(73) Assignee: ADVICS CO., LTD., Kariya-shi, Aichi-ken (JP)

(21) Appl. No.: 19/488,355

(22) PCT Filed: May 29, 2024
(86) PCT No.: PCT/JP2024/019753

§ 371 Date: Nov. 26, 2025

(30) Foreign Application Priority Data
May 29, 2023 (JP) 2023-087676
Jul. 12, 2023 (JP) 2023-114583

(51) Int. Cl. B60T 13/74; B60T 13/14; B60T 13/66

(52) U.S. Cl. CPC B60T 13/745; B60T 13/142; B60T 13/148; B60T 13/662

(57) ABSTRACT

An electric braking device includes a shut-off valve configured to switch a connection path connecting a reservoir tank and a wheel cylinder between a communication state and a shut-off state, an electric cylinder connected to a main flow path that is a portion of the connection path between the shut-off valve and the wheel cylinder, and a control unit. The control unit generates a brake hydraulic pressure in the wheel cylinder by causing the electric cylinder to discharge a brake fluid to the main flow path in a state where the main flow path is shut off by the shut-off valve. The control unit maintains a shut-off state of the main flow path by the shut-off valve even after the brake hydraulic pressure generated in the wheel cylinder decreases to an atmospheric pressure due to suction of the brake fluid from the main flow path by the electric cylinder.

### TECHNICAL FIELD

The disclosure here relates to an electric braking device.

### BACKGROUND ART

PTL 1 discloses an electric braking device that transmits a hydraulic pressure generated by an electric cylinder to a wheel cylinder to generate a braking force on a wheel. In this electric braking device, a hydraulic circuit between the electric cylinder and the wheel cylinder and a reservoir tank are connected via an electromagnetic shut-off valve.

### CITATION LIST

### Patent Literature

PTL 1: JP2010-95023A

### SUMMARY

### Technical Problem

In the electric braking device as described above, it is conceivable that the hydraulic circuit is configured such that a brake fluid discharged from the electric cylinder is returned to the reservoir tank in a state where the shut-off valve is opened. In the electric braking device having such a configuration, it is necessary to close the shut-off valve before starting a pressurizing operation of the electric cylinder in response to a braking request. In order to keep an operation feeling constant, it is necessary to increase an operation speed of the shut-off valve at this time. The reason for this is as follows. When the operation speed of the shut-off valve is low, the brake fluid in a master cylinder flows into the wheel cylinder via the shut-off valve in response to an operation of a brake pedal. As a result, the operation feeling changes. However, when the operation speed of the shut-off valve is increased, an operation sound of the shut-off valve increases, which may cause an occupant to feel uncomfortable.

### Solution to Problem

In order to solve the above problems, there is provided an electric braking device including: a shut-off valve provided in a connection path connecting a reservoir tank and a wheel cylinder, and configured to switch the connection path between a communication state and a shut-off state; and an electric cylinder connected to a main flow path between the shut-off valve and the wheel cylinder, and configured to discharge a brake fluid to the main flow path and suction the brake fluid from the main flow path by linearly moving a piston in the cylinder in response to driving by an electric motor, in which a brake hydraulic pressure is generated in the wheel cylinder by discharging the brake fluid to the main flow path by the electric cylinder in a shut-off state of the main flow path by the shut-off valve, and the electric braking device includes a control unit configured to maintain the shut-off state of the main flow path by the shut-off valve even after the brake hydraulic pressure generated in the wheel cylinder decreases to an atmospheric pressure due to suction of the brake fluid from the main flow path by the electric cylinder.

### Advantageous Effects

Generation of an operation sound of a shut-off valve is restricted while maintaining an operation feeling constant.

### BRIEF DESCRIPTION OF DRAWINGS

FIG. 1 is a diagram schematically illustrating a configuration of an electric braking device according to a first embodiment.

FIG. 2 is a flowchart of a braking control routine executed by a control unit of the electric braking device.

FIG. 3 is a graph illustrating a relationship between a peak value and a retraction amount.

FIG. 4 is a diagram schematically illustrating a state of the electric braking device during braking force generation.

FIG. 5 is a diagram schematically illustrating a state of the electric braking device at the end of braking.

FIG. 6 is a diagram schematically illustrating a state of the electric braking device during retraction control.

FIG. 7 is a diagram schematically illustrating a state of the electric braking device when knock-back occurs.

FIG. 8 is a graph illustrating a relationship between a hydraulic pressure and a caliper piston forward movement amount.

FIG. 9 is a flowchart illustrating a part of a braking control routine executed by a control unit of an electric braking device according to a second embodiment.

FIG. 10 is a time chart illustrating an example of a control mode at the time of braking release in the electric braking device of the second embodiment, in which (a) illustrates a transition of a brake hydraulic pressure, (b) illustrates a transition of a screw stroke, and (c) illustrates a transition of open and closed states of a shut-off valve.

### DESCRIPTION OF EMBODIMENTS

### First Embodiment

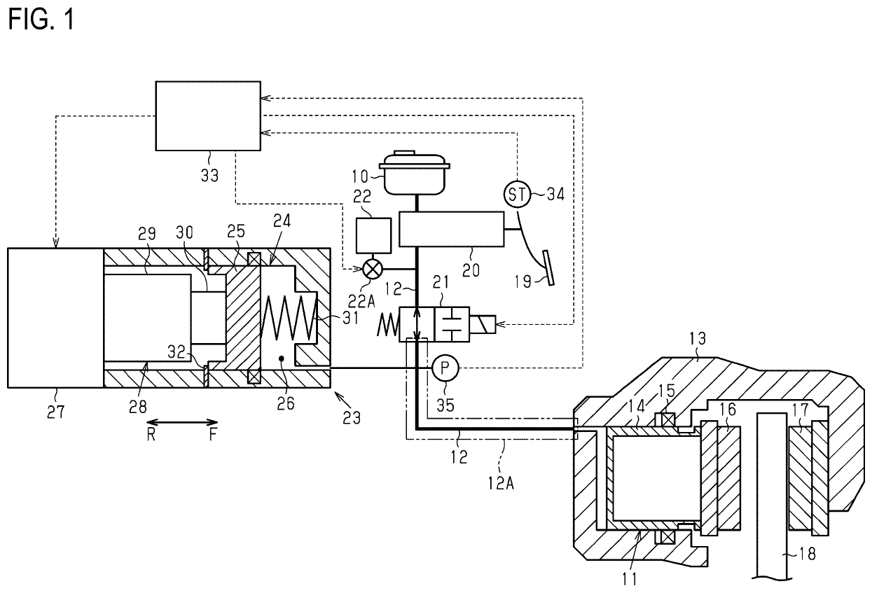

Hereinafter, an electric braking device according to a first embodiment will be described with reference to FIGS. 1 to 8. The electric braking device according to the embodiment is implemented as a device that generates a braking force on a wheel of a vehicle.

### Configuration of Electric Braking Device

As illustrated in FIG. 1, the electric braking device according to the embodiment includes a reservoir tank 10 configured to store a brake fluid, and a wheel cylinder 11 configured to generate a braking force on the wheel in response to supply of a brake hydraulic pressure. The electric braking device further includes a connection path 12 that is a fluid path connecting the reservoir tank 10 and the wheel cylinder 11. In the following description, a side closer to the wheel cylinder 11 along the connection path 12 is referred to as a downstream side of the connection path 12. A side closer to the reservoir tank 10 along the connection path 12 is referred to as an upstream side of the connection path 12.

The wheel cylinder 11 is provided inside a caliper 13 provided at the wheel of the vehicle. A caliper piston 14 is accommodated inside the wheel cylinder 11 so as to be linearly movable. The wheel cylinder 11 is provided with a seal member 15 that elastically contacts a side surface of the caliper piston 14. Two friction materials 16 and 17 are provided in the caliper 13. The two friction materials 16 and 17 are disposed so as to sandwich a brake rotor 18, which is a rotary body rotating together with the wheel. The caliper piston 14 presses the friction material 16 toward the brake rotor 18 in response to the supply of the brake hydraulic pressure to the wheel cylinder 11. Accordingly, the brake rotor 18 is sandwiched by the two friction materials 16 and 17. Friction between the brake rotor 18 and the friction materials 16 and 17 at this time generates the braking force on the wheel.

The connection path 12 is provided with a master cylinder 20 configured to generate a brake hydraulic pressure in response to depression of a brake pedal 19. The master cylinder 20 supplies and discharges the brake fluid in response to an operation of the brake pedal 19 as an operation member. A normally open shut-off valve 21 is provided in a portion of the connection path 12 downstream of the master cylinder 20. That is, the master cylinder 20 is provided in a portion of the connection path 12 between the reservoir tank 10 and the shut-off valve 21. When the shut-off valve 21 is opened, the connection path 12 is in a communication state where the reservoir tank 10 and the wheel cylinder 11 communicate with each other. When the shut-off valve 21 is closed, the connection path 12 is in a shut-off state where the reservoir tank 10 and the wheel cylinder 11 are shut off from each other. That is, the shut-off valve 21 is a valve configured to switch the connection path 12 between the communication state and the shut-off state.

Further, a stroke simulator 22 is connected to a portion of the connection path 12 between the master cylinder 20 and the shut-off valve 21 via an electromagnetically driven cut valve 22A. A plunger supported by a spring is built in the stroke simulator 22. The cut valve 22A is closed when the shut-off valve 21 is opened. Therefore, when the shut-off valve 21 is opened, the brake hydraulic pressure generated by the master cylinder 20 in response to the depression of the brake pedal 19 is supplied to the wheel cylinder 11. When the shut-off valve 21 is closed, the master cylinder 20 and the wheel cylinder 11 are shut off from each other, and the cut valve 22A is opened. At this time, the stroke simulator 22 absorbs the flow of the brake fluid discharged from the master cylinder 20 by the movement of the built-in plunger, and simultaneously generates a reaction force against the depression of the brake pedal 19.

In the following description, a portion of the connection path 12 between the shut-off valve 21 and the wheel cylinder 11 is referred to as a main flow path 12A. An electric cylinder 23 is connected to the main flow path 12A. The electric cylinder 23 is operated when supplied with power to generate a brake hydraulic pressure. The electric cylinder 23 is provided with a cylinder 24 in which a piston 25 is accommodated so as to be linearly movable. Inside the cylinder 24, a fluid chamber 26 into which the brake fluid is introduced is partitioned by the piston 25. The fluid chamber 26 communicates with the connection path 12. The volume of the fluid chamber 26 changes as the piston 25 linearly moves in the cylinder 24. In the following description, among linear motion directions of the piston 25 in the cylinder 24, a direction in which the volume of the fluid chamber 26 decreases is referred to as a forward direction F, and a direction in which the volume of the fluid chamber 26 increases is referred to as a backward direction R.

The electric cylinder 23 includes an actuator 27 and a linear motion conversion mechanism 28. The actuator 27 is supplied with power to generate a rotational force. The actuator 27 includes, for example, an electric motor and a deceleration mechanism configured to decelerate the rotation of the electric motor. The linear motion conversion mechanism 28 includes a rotary member 29 configured to rotate when receiving the rotation of the actuator 27. The linear motion conversion mechanism 28 includes a linear motion member 30 configured to linearly move in the forward direction F and the backward direction R in accordance with the rotation of the rotary member 29. Examples of the linear motion conversion mechanism 28 include a ball screw mechanism and a trapezoidal screw mechanism. The linear motion member 30 moves in the forward direction F to come into contact with the piston 25. The linear motion member 30 further moves in the forward direction F while being in contact with the piston 25, thereby pressing the piston 25. Accordingly, the piston 25 presses the brake fluid in the fluid chamber 26, so that the electric cylinder 23 discharges the brake fluid to the main flow path 12A. The linear motion direction of the linear motion member 30 is switched according to a rotation direction of the actuator 27. In the following description, rotational drive of the actuator 27 in a direction of moving the linear motion member 30 in the forward direction F is referred to as forward drive of the actuator 27. Further, the rotational drive of the actuator 27 in a direction of moving the linear motion member 30 in the backward direction R is referred to as backward drive of the actuator 27.

The electric cylinder 23 is provided with a spring 31 and a stopper 32. The spring 31 is installed in the fluid chamber 26. The spring 31 generates a compression reaction force against the pressing in the forward direction F from the piston 25. The stopper 32 comes into contact with the piston 25 at a predetermined position in the cylinder 24 and prohibits the piston 25 from moving in the backward direction R from the position. In the following description, a movement position of the piston 25 in contact with the stopper 32 is referred to as an initial position.

As described above, the electric cylinder 23 includes the piston 25 configured to linearly move in the cylinder 24 according to drive of the electric motor in the actuator 27. By the linear motion of the piston 25 in the cylinder 24, the electric cylinder 23 can discharge the brake fluid to the main flow path 12A and suctions the brake fluid from the main flow path 12A.

Further, the electric braking device according to the embodiment includes a control unit 33. The control unit 33 is an electronic control unit for brake control. A stroke sensor 34 and a hydraulic pressure sensor 35 are connected to the control unit 33. The stroke sensor 34 is a sensor configured to detect a pedal stroke ST that is a depression amount of the brake pedal 19. The hydraulic pressure sensor 35 is a sensor configured to detect a brake hydraulic pressure P that is a pressure of the brake fluid in the main flow path 12A. The brake hydraulic pressure P detected by the hydraulic pressure sensor 35 indicates the brake hydraulic pressure in the wheel cylinder 11. When the shut-off valve 21 is closed, the brake hydraulic pressure P detected by the hydraulic pressure sensor 35 indicates the brake hydraulic pressure generated by the electric cylinder 23.

The control unit 33 opens and closes the shut-off valve 21 by turning on and off the energization of the shut-off valve 21. Since the cut valve 22A is closed when the shut-off valve 21 is opened, the brake hydraulic pressure P generated by the master cylinder 20 in response to the depression of the brake pedal 19 is supplied to the wheel cylinder 11. On the other hand, when the shut-off valve 21 is closed, the master cylinder 20 is disconnected from the wheel cylinder 11. The control unit 33 performs drive control of the electric cylinder 23 based on a detection result of the pedal stroke ST by the stroke sensor 34 and the like in a state where the shut-off valve 21 is closed and the cut valve 22A is opened, thereby performing braking control by a by-wire system.

### Braking Control of By-Wire System

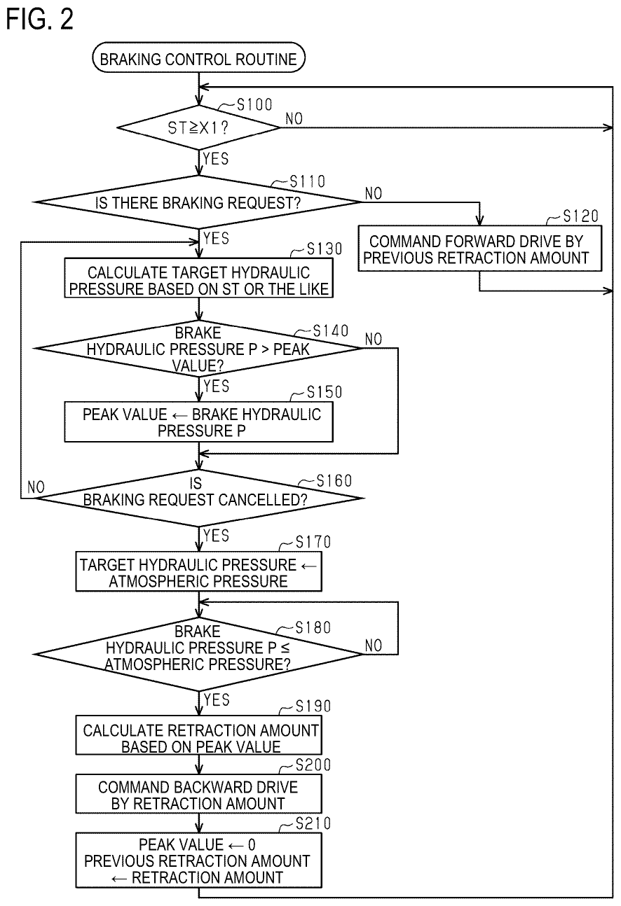

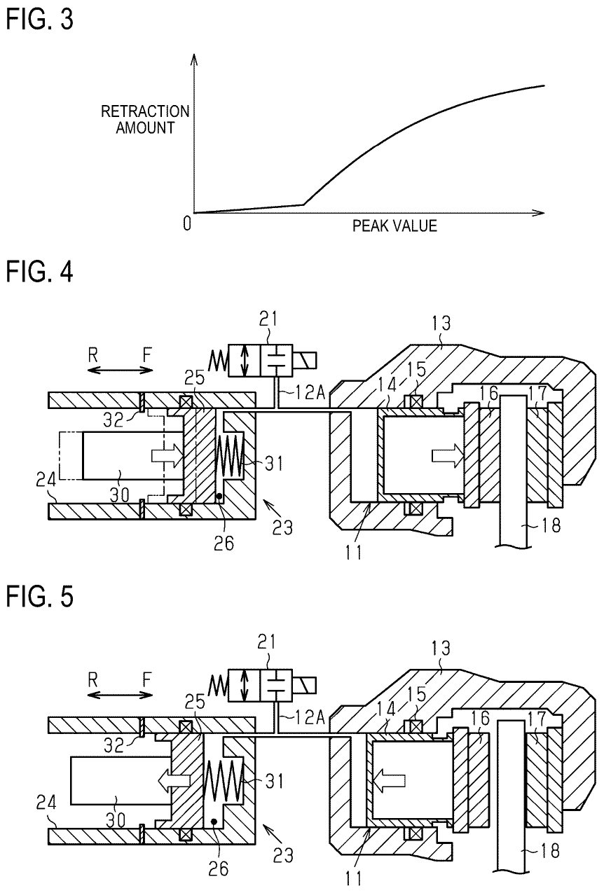

Next, details of the braking control by the by-wire system will be described with reference to FIGS. 2 and 3. FIG. 2 illustrates a flowchart of a braking control routine executed by the control unit 33. The control unit 33 performs initialization processing before entering the braking control routine and when there is no driver operation. The initialization processing is performed as follows. In the initialization processing, the control unit 33 drives the electric cylinder 23 so as to advance the piston 25 of the electric cylinder 23 from the initial position to a control initial position in a state where the shut-off valve 21 is opened. Then, the control unit 33 closes the shut-off valve 21 after driving the electric cylinder 23. The control initial position is a position that the piston 25 reaches after advancing from the initial position by a certain amount. When such initialization processing is not performed, the hydraulic pressure may be already higher than the atmospheric pressure at the start of the braking control routine, that is, the hydraulic pressure may be confined. Even in such a case, the initialization processing is performed to reduce the hydraulic pressure at the start of the braking control routine to the atmospheric pressure. Then, the control unit 33 starts this routine in response to the start of the braking control by the by-wire system. By performing the initialization processing, at the start of the braking control, the piston 25 of the electric cylinder 23 is positioned at the control initial position, and the shut-off valve 21 is in a closed state. In addition, 0 is set as an initial value for each of a previous retraction amount and a peak value described later.

When the control unit 33 starts the braking control by the by-wire system, first, in step S100, the control unit 33 determines whether the pedal stroke ST is equal to or greater than a predetermined value X1. The predetermined value X1 is set to a positive value smaller than a threshold of the pedal stroke ST for determining that there is a braking request. When the pedal stroke ST is less than the predetermined value X1 (NO), the control unit 33 performs the determination in step S100 again after a predetermined control cycle T elapses.

When the pedal stroke ST is equal to or greater than the predetermined value X1, (S100: YES), the control unit 33 determines in step S110 whether there is a braking request. The control unit 33 determines that there is a braking request if the pedal stroke ST is equal to or greater than a predetermined value X2 larger than the determined value X1.

When the control unit 33 determines that there is no braking request (NO), in step S120, the control unit 33 commands the actuator 27 to perform the forward drive by the previous retraction amount. Then, after the control cycle T elapses, the control unit 33 performs the determination in step S100 again. When the processing of step S120 is performed, that is, when the pedal stroke ST is equal to or greater than the predetermined value X1 and less than the predetermined value X2, it means that the brake pedal 19 is depressed lightly so as not to generate the braking force.

On the other hand, when it is determined that there is a braking request (S110: YES), the control unit 33 calculates a target hydraulic pressure based on the pedal stroke ST and the like in step S130. The target hydraulic pressure is a target value of the brake hydraulic pressure P to be generated in the electric cylinder 23. When the target hydraulic pressure is set, the control unit 33 performs drive control of the actuator 27 of the electric cylinder 23 in a routine different from the present routine such that the brake hydraulic pressure P detected by the hydraulic pressure sensor 35 approaches the target hydraulic pressure.

Subsequently, in step S140, the control unit 33 determines whether the current brake hydraulic pressure P detected by the hydraulic pressure sensor 35 exceeds a stored peak value. When the current brake hydraulic pressure P exceeds the peak value (YES), the control unit 33 replaces the value of the peak value with the current brake hydraulic pressure P in step S150, and then advances the processing to step S160. On the other hand, when the current brake hydraulic pressure P is equal to or less than the peak value (NO), the control unit 33 skips step S150 and advances the processing to step S160. The peak value represents the maximum value of the brake hydraulic pressure P in the wheel cylinder 11 increased by the electric cylinder 23 during the current generation of the braking force.

When the processing is advanced to step S160, the control unit 33 determines whether the braking request is canceled after the control cycle T elapses. Specifically, the control unit 33 determines whether the pedal stroke ST is less than the predetermined value X2. When the braking request is not canceled (NO), the control unit 33 executes the processing of steps S130 to S160 again.

On the other hand, when the braking request is canceled (YES), the control unit 33 sets the atmospheric pressure as the value of the target hydraulic pressure in step S170. Then, when the brake hydraulic pressure P decreases to the atmospheric pressure or lower (S180: YES), the control unit 33 advances the processing to step S190.

In step S190, the control unit 33 calculates the retraction amount based on the peak value. Then, in the next step S200, the control unit 33 commands the actuator 27 to perform the backward drive by the retraction amount. The control unit 33 commands the backward drive of the actuator 27 on condition that a state where the pedal stroke ST is 0 continues for a predetermined time or longer. The control unit 33 fixes the speed of the backward drive of the actuator 27 at this time to a predetermined speed.

Thereafter, in step S210, the control unit 33 resets the peak value to 0 and stores the retraction amount calculated in step S190 as a value of the previous retraction amount. Then, the control unit 33 returns the processing to step S100 after the control cycle T elapses.

FIG. 3 Illustrates a Relationship Between the retraction amount calculated by the control unit 33 in step S190 and the peak value used for the calculation. The control unit 33 calculates a larger value as the value of the retraction amount as the peak value is larger.

A plurality of control cycles T may be required for drive of the actuator 27 based on the forward drive command in step S120 and the backward drive command in step S200. The braking request may be generated before the drive of the actuator 27 based on these commands is completed. In such a case, the control unit 33 cancels these commands. Then, the control unit 33 performs the processing in the case where it is determined in step S110 that there is a braking request, thereby controlling the electric braking device so as to generate the braking force in response to the request.

### Operations and Effects of First Embodiment

Operations and effects of the embodiment will be described.

The control unit 33 maintains the energization of the shut-off valve 21 during the braking control by the by-wire system. Therefore, the main flow path 12A during the braking control is shut off from the reservoir tank 10.

FIG. 4 illustrates a state of the electric braking device during braking. When the brake pedal 19 is depressed and the pedal stroke ST is equal to or greater than the predetermined value X2, the control unit 33 commands the forward drive of the actuator 27 of the electric cylinder 23. Accordingly, the piston 25 presses the brake fluid in the fluid chamber 26, so that the electric cylinder 23 generates the brake hydraulic pressure P. The brake hydraulic pressure P generated by the electric cylinder 23 is transmitted to the wheel cylinder 11. The caliper piston 14 presses the friction material 16 by the transmitted brake hydraulic pressure P. Accordingly, the brake rotor 18 is sandwiched by the two friction materials 16 and 17. With the friction generated between the brake rotor 18 and the friction materials 16 and 17 at this time, the braking force is generated on the wheel.

FIG. 5 illustrates a state of the electric braking device at the end of braking. When the pedal stroke ST is less than the predetermined value X1, the control unit 33 determines that the braking request is canceled. The control unit 33 commands the backward drive of the actuator 27 of the electric cylinder 23 until the brake hydraulic pressure P detected by the hydraulic pressure sensor 35 decreases to the atmospheric pressure.

Thereafter, when the state where the pedal stroke ST is 0 continues for a predetermined time or longer, the control unit 33 commands the drive of the actuator 27 in the backward direction R further from a position at the end of braking. In the following description, the control of performing the backward drive of the actuator 27 after the end of braking is referred to as retraction control. The control unit 33 executes the retraction control in a state where the brake hydraulic pressure P generated in the wheel cylinder 11 is reduced to the atmospheric pressure and the shut-off state of the main flow path 12A by the shut-off valve 21 is maintained. In the retraction control, the control unit 33 drives the electric cylinder 23 in a direction in which the brake fluid is suctioned from the main flow path 12A.

In the electric braking device according to the embodiment, for the retraction control, the actuator 27 of the electric cylinder 23 is driven after the end of braking. When the electric braking device generates an operation sound after the end of braking for the retraction control, an occupant may feel uncomfortable. In contrast, the control unit 33 of the electric braking device according to the embodiment fixes a drive speed of the actuator 27 in the backward direction R in the retraction control to a predetermined speed. The fixed speed is set to a speed equal to or lower than an upper limit speed of the actuator 27 at which the operation sound remains at a magnitude that does not cause the occupant to feel uncomfortable. Therefore, the operation sound of the actuator 27 in the retraction control after the end of braking is reduced to a magnitude that does not cause the occupant to feel uncomfortable.

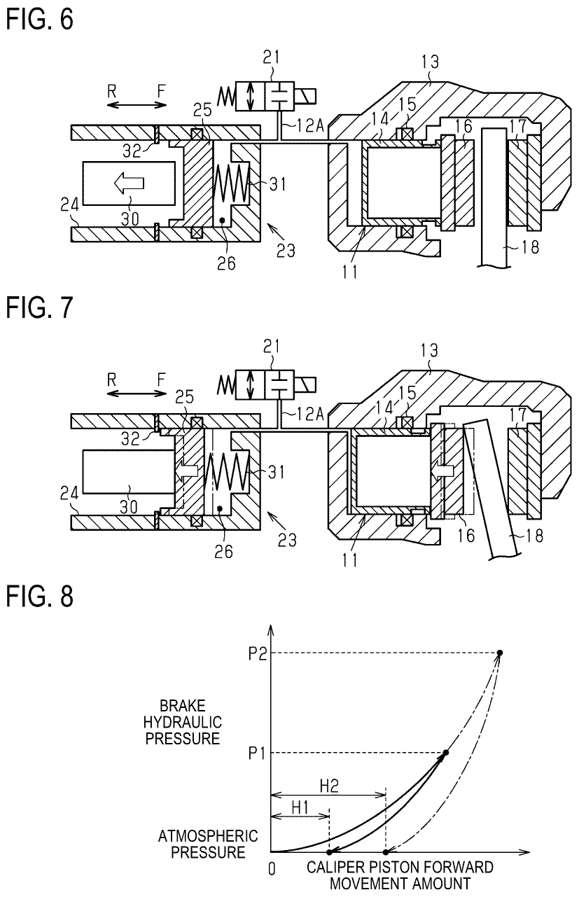

FIG. 6 illustrates a state of the electric braking device during the retraction control. When the retraction control is performed, the linear motion member 30 of the linear motion conversion mechanism 28 of the electric cylinder 23 moves in the backward direction R from the position at the end of braking. Accordingly, the piston 25 of the electric cylinder 23 is allowed to move in the backward direction R from the position at the end of braking. At this time, a hydraulic circuit between the electric cylinder 23 and the wheel cylinder 11 is closed by closing the shut-off valve 21. Therefore, the caliper piston 14 of the wheel cylinder 11 moves in conjunction with the piston 25 of the electric cylinder 23. Therefore, by the retraction control, the caliper piston 14 is allowed to move in a direction away from the friction material 16 from the position at the end of braking.

When the retraction control is ended, the control unit 33 stops driving the electric cylinder 23 until braking is requested again. As described above, at the time of non-braking, the control unit 33 causes the electric cylinder 23 to stand by in a state where the piston 25 is positioned at an operating position where the brake hydraulic pressure P is not generated.

While the vehicle is traveling, the caliper piston 14 may be pushed back by the brake rotor 18 due to vibration or displacement of the brake rotor 18. This phenomenon is called knock-back. The knock-back may occur during hard cornering or rough road traveling. In a case where the retraction control is not performed, the piston 25 of the electric cylinder 23 cannot retract when the caliper piston 14 is pushed back due to the knock-back. Therefore, during the knock-back, drag occurs when the brake rotor 18 is pressed against the friction material 16.

On the other hand, if the shut-off valve 21 is opened after the end of braking, the brake fluid pushed out by the backward movement of the caliper piston 14 is released to the reservoir tank 10, so that the occurrence of drag at the time of knock-back can be restricted. However, in such a case, the total amount of the brake fluid present inside the main flow path 12A, the electric cylinder 23, and the wheel cylinder 11 decreases by the amount of the brake fluid returned to the reservoir tank 10. Therefore, the responsiveness at the time of the next braking decreases.

FIG. 7 illustrates a state of the electric braking device according to the embodiment when the knock-back occurs. As described above, in the electric braking device according to the embodiment, the retraction control is performed after the end of braking, so that the piston 25 of the electric cylinder 23 is allowed to move in the backward direction R. Therefore, the piston 25 moves in the backward direction R and the brake fluid pushed out from the wheel cylinder 11 by the knock-back is absorbed into the electric cylinder 23, so that the occurrence of drag can be restricted. Also at this time, since the total amount of the brake fluid present inside the main flow path 12A, the electric cylinder 23, and the wheel cylinder 11 does not change, a decrease in responsiveness at the time of the next braking is also restricted.

In the case where the retraction control is performed, an operating position of the actuator 27 is a position in the backward direction R as compared with the case where the retraction control is not performed. Therefore, when a state where the retraction control is performed is maintained until the start of the next braking, the amount of forward drive of the actuator 27 required to start braking increases. The responsiveness at the time of braking decreases accordingly. On the other hand, in the electric braking device according to the embodiment, at a time point when the pedal stroke ST is equal to or greater than the predetermined value X1 (<X2), the control unit 33 commands the forward drive of the actuator 27 by the same amount as the retraction amount in the previous retraction control. Accordingly, the operating position of the actuator 27 at the start of braking is a position in the forward direction F with respect to the position at the end of the retraction control. Therefore, a decrease in responsiveness at the time of braking associated with the retraction control is restricted.

As described above, the control unit 33 maintains the shut-off state of the main flow path 12A by the shut-off valve 21 even after the brake hydraulic pressure P generated in the wheel cylinder 11 decreases to the atmospheric pressure due to the suction of the brake fluid from the main flow path 12A by the electric cylinder 23. In the electric braking device according to the embodiment, since it is not necessary to operate the shut-off valve 21 for each braking, the frequency at which the shut-off valve 21 generates the operation sound is reduced. Therefore, the electric braking device according to the embodiment has an effect of restricting the shut-off valve 21 from generating the operation sound that may cause the occupant to feel uncomfortable.

### Retraction Amount of Actuator 27 in Retraction Control

FIG. 8 illustrates transitions of the brake hydraulic pressure P and a forward movement amount of the caliper piston 14 in a period from the start of braking to the end of braking in each of a case where the peak value of the brake hydraulic pressure P during braking is P1 and a case where the peak value is P2 larger than P1. As illustrated in FIG. 8, even when the brake hydraulic pressure P in the wheel cylinder 11 decreases to the atmospheric pressure after the braking ends, the caliper piston 14 does not completely return to the position at the start of braking. A position of the caliper piston 14 at the end of braking is a position forward of the position at the start of braking.

In the following description, a difference in the forward movement amount of the caliper piston 14 between braking start and braking end is referred to as hysteresis. The hysteresis in the forward movement amount of the caliper piston 14 increases as the peak value of the brake hydraulic pressure P during braking increases. For example, in the case of FIG. 8, hysteresis H2 when the peak value is P2 is larger than hysteresis H1 when the peak value is P1. Therefore, in a case where the retraction amount is constant, a position of the linear motion member 30 of the actuator 27 after the retraction control is a position farther in the forward direction F when the peak value is large than when the peak value is small. As the position of the linear motion member 30 after the retraction control is farther in the forward direction F, an allowable retraction amount of the caliper piston 14 is smaller. Then, since the allowable retraction amount of the caliper piston 14 decreases, the drag restriction effect at the time of knock-back is reduced.

On the other hand, in the electric braking device according to the embodiment, the control unit 33 stores the peak value of the brake hydraulic pressure P in the wheel cylinder 11 increased by the electric cylinder 23 during the generation of the braking force. The control unit 33 determines the retraction amount in the retraction control based on the peak value during the last braking force generation. The retraction amount represents a drive amount of the actuator 27 in the backward direction R in the retraction control. As illustrated in FIG. 3, the control unit 33 determines a larger value as the value of the retraction amount as the peak value is larger. Therefore, regardless of the peak value of the brake hydraulic pressure P in the last braking, the drag restriction effect at the time of knock-back can be maintained.

### Second Embodiment

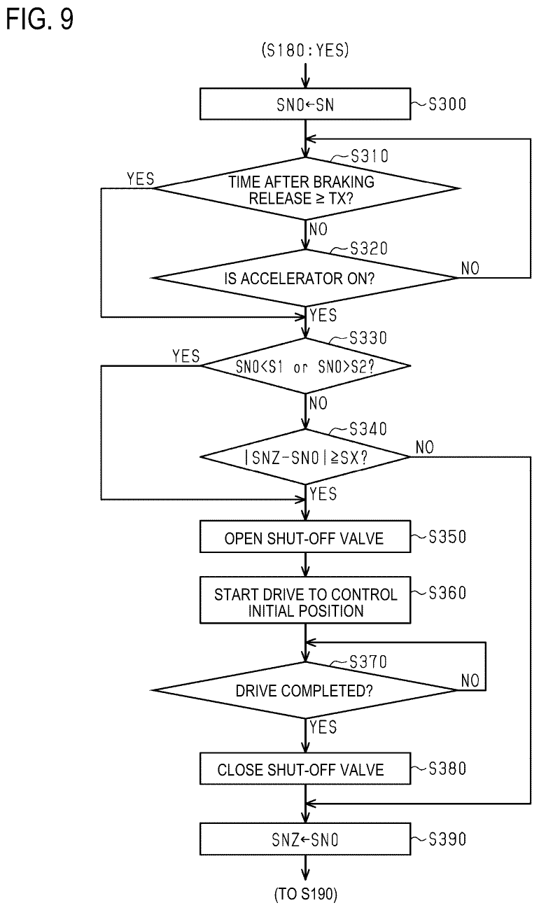

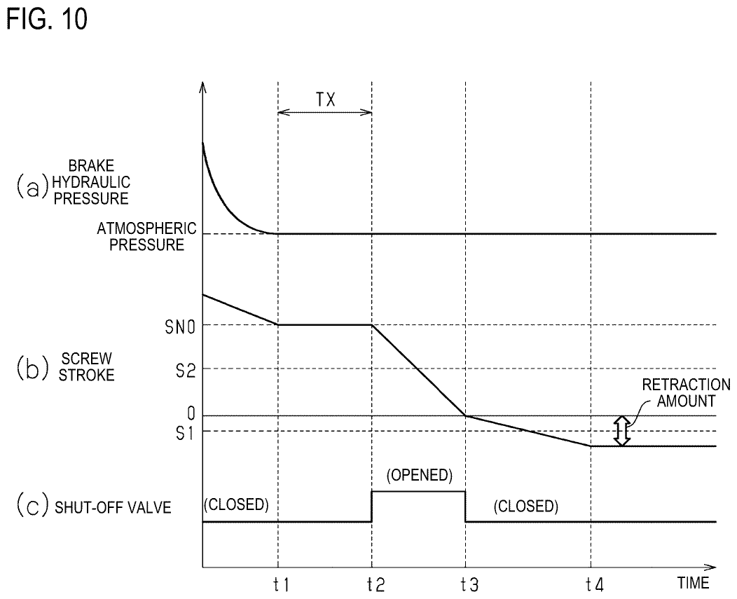

An electric braking device according to a second embodiment will be described with reference to FIGS. 9 and 10. The electric braking device according to the embodiment has the same configuration as that of the first embodiment illustrated in FIG. 1. In the embodiment, the same components as those in the above embodiment are denoted by the same reference signs, and a detailed description thereof is omitted.

In the following description, a “screw stroke SN” represents a drive amount of the actuator 27. More specifically, a value of the screw stroke SN represents a drive amount of the linear motion member 30 in the forward direction F from the position of the linear motion member 30 when the piston 25 is driven to the control initial position in the initialization processing.

FIG. 9 illustrates a part of processing of a braking control routine executed by the control unit 33 in the electric braking device according to the embodiment. The control unit 33 of the electric braking device according to the embodiment starts the processing in FIG. 9 when it is determined as “YES” in step S180 in FIG. 2. That is, the flowchart of FIG. 9 illustrates processing started when the brake hydraulic pressure P decreases to the atmospheric pressure after the cancellation of the braking request in the electric braking device according to the embodiment. Even during the processing in FIG. 9, when the brake pedal 19 is depressed and a braking request is generated, the control unit 33 advances the processing to step S130 in FIG. 2 at that time.

When the processing proceeds to the processing in FIG. 9, the control unit 33 records the value of the current screw stroke SN as the value of a release stroke SN0 in step S300. The release stroke SNO represents a value of the screw stroke SN when the brake hydraulic pressure P decreases to the atmospheric pressure after the cancellation of the braking request.

Thereafter, when any one of the following conditions (A) and (B) is satisfied, the control unit 33 advances the processing to step S330. The condition (A) is that a time after braking release, which is an elapsed time from the cancellation of the braking request, is equal to or longer than a predetermined time TX (S310: YES). The condition (B) is that an accelerator is on, that is, an accelerator pedal is depressed (S320: YES). The satisfaction of these conditions (A) and (B) indicates a situation where a probability of operating the brake pedal after the cancellation of the braking request is lower than a predetermined threshold.

When the processing is advanced to step S330, the control unit 33 determines whether to execute adjustment control. Specifically, in step S330, the control unit 33 determines whether a relationship between the brake hydraulic pressure P and the position of the piston 25 deviates from a relationship set in advance. In step S340, the control unit 33 determines whether the relationship between the brake hydraulic pressure P and the position of the piston 25 is changed by a predetermined value or more before and after the operation of the electric cylinder 23. The control unit 33 advances the processing to step S350 to execute the adjustment control when the above relationship deviates from the relationship set in advance (S330: YES), or when the above relationship is changed by the predetermined value or more before and after the operation of the electric cylinder 23 (S340: YES).

The determination in step S330 will be described. In the embodiment, a case where the release stroke SN0 is equal to or greater than a predetermined value S1 and equal to or less than a predetermined value S2 is a case where the brake hydraulic pressure P and the position of the piston 25 are in the relationship set in advance. Therefore, in step S330, when the release stroke SN0 is less than the predetermined value S1 or exceeds the predetermined value S2, the control unit 33 determines that the relationship deviates from the relationship set in advance. The predetermined value S1 is set to a value of the screw stroke SN when the piston 25 is positioned in the forward direction F from the initial position and in the backward direction R from the control initial position. The predetermined value S2 is set to a value obtained by subtracting a required forward movement amount from the maximum forward position of the piston 25 and subtracting a margin from the value obtained by subtracting the required forward movement amount. The maximum forward position represents a limit position in the forward direction F in a drive range of the piston 25 in the electric cylinder 23. The required forward movement amount represents a drive amount for the piston 25 in the forward direction F required to increase the brake hydraulic pressure P from the atmospheric pressure to a required maximum pressure during braking.

Next, the determination in step S340 will be described. “SNZ” in FIG. 9 represents a previous release stroke that is a value of the release stroke SN0 in the previous braking. In step S340, the control unit 33 obtains a change width (=|SNZ−SN0|) of the value of the release stroke SNO between the previous braking and the current braking. When the change width is equal to or greater than a predetermined value SX, the control unit 33 determines that the relationship is changed by the predetermined value or more before and after the operation of the electric cylinder 23.

When executing the adjustment control, the control unit 33 first opens the shut-off valve 21 in step S350. Subsequently, in step S360, the control unit 33 commands the actuator 27 to drive the piston 25 to the control initial position. When the driving of the piston 25 to the control initial position is completed (S370: YES), the control unit 33 closes the shut-off valve 21 (S380). In the embodiment, the processing in steps S350 to S380 corresponds to the processing for adjustment control.

When the adjustment control is completed, the control unit 33 advances the processing to step S390. When the adjustment processing is not to be executed (S330: NO and S340: NO), the control unit 33 skips steps S350 to S380 and advances the processing to step S390. In step S390, the control unit 33 records the value of the release stroke SN0 in the current braking as the value of the previous release stroke SNZ. The control unit 33 advances the processing to step S190 in FIG. 2 and executes the retraction control.

### Operations and Effects of Second Embodiment

Operations and effects of the embodiment will be described.

FIG. 10 illustrates an example of an implementation mode of the adjustment control in the electric braking device according to the embodiment. (a) of FIG. 10 illustrates the transition of the brake hydraulic pressure P, (b) of FIG. 10 illustrates a transition of the screw stroke SN, and (c) of FIG. 10 illustrates a transition of open and closed states of the shut-off valve 21.

In FIG. 10, the brake hydraulic pressure P decreases to the atmospheric pressure at a time point t1. In the case of FIG. 10, the screw stroke SN at this time, that is, the release stroke SNO exceeds the predetermined value S2. In this case, the control unit 33 determines that the relationship between the brake hydraulic pressure P and the position of the piston 25 deviates from the relationship set in advance. On the other hand, the control unit 33 determines that the probability of operating the brake pedal 19 is lower than the predetermined threshold at a time point t2 after elapse of the predetermined time TX from the time point t1 when the brake hydraulic pressure P is reduced to the atmospheric pressure. Then, the control unit 33 starts the adjustment control at the time point t2. Specifically, the control unit 33 opens the shut-off valve 21 at the time point t2 and commands the actuator 27 to drive the piston 25 to the control initial position. In this case, driving of the piston 25 in the backward direction R is commanded.

In the embodiment, the screw stroke SN is defined such that the value is “0” when the piston 25 is located at the control initial position. Therefore, in FIG. 10, the piston 25 reaches the control initial position at a time point t3 when the value of the screw stroke SN is 0. The control unit 33 ends the adjustment control by closing the shut-off valve 21 at the time point t3. When the shut-off valve 21 is opened, the main flow path 12A communicates with the reservoir tank 10. Therefore, as a result of the adjustment control, the relationship between the brake hydraulic pressure P and the position of the piston 25 is adjusted such that the brake hydraulic pressure P is the atmospheric pressure when the piston 25 is located at the control initial position.

The control unit 33 starts the retraction control from the time point t3 when the adjustment control is ended. Specifically, the control unit 33 commands the actuator 27 to drive in the backward direction R by the retraction amount set according to the peak value of the brake hydraulic pressure P during braking. In the case of FIG. 10, the retraction control is completed at a time point t4 thereafter.

In FIG. 10, the case where the release stroke SN0 exceeds the predetermined value S2 is illustrated. When the release stroke SN0 is less than the predetermined value S1, the control unit 33 also determines that the relationship between the brake hydraulic pressure P and the position of the piston 25 deviates from the relationship set in advance and performs the adjustment control. In the adjustment control, in FIG. 10, driving of the piston 25 in the backward direction R is commanded at the time point t2 to move the piston 25 to the control initial position. In contrast, when the release stroke SNO is less than the predetermined value S1, the piston 25 is commanded to be driven in the forward direction F at the time point t2 and the piston 25 is moved to the control initial position, which is different from the case of FIG. 10. Other operations are the same as those in FIG. 10.

As described above, in the electric braking device according to the embodiment, in the initialization processing, the brake fluid amounts in the electric cylinder 23, the main flow path 12A, and the wheel cylinder 11 are adjusted such that the brake hydraulic pressure P is the atmospheric pressure when the piston 25 is located at the control initial position. The electric braking device increases the brake hydraulic pressure P, which is supplied to the wheel cylinder 11, from the atmospheric pressure by driving the piston 25 in the forward direction F from the control initial position.

In such an electric braking device, after the initialization processing is performed, the relationship between the position of the piston 25 and the brake hydraulic pressure P may change due to wear of the friction materials 16 and 17, thermal expansion of the brake fluid, or the like. As a result, even when the piston 25 is retracted to the initial position, the brake hydraulic pressure P may not decrease to the atmospheric pressure, or even when the piston 25 is advanced to the maximum forward position, the brake hydraulic pressure P may not reach the required maximum pressure.

In contrast, the control unit 33 in the electric braking device according to the embodiment performs the adjustment control for adjusting the relationship between the brake hydraulic pressure P and the position of the piston 25. The control unit 33 starts the adjustment control in the state where the brake hydraulic pressure P generated in the wheel cylinder 11 is reduced to the atmospheric pressure and the main flow path 12A is shut off from the reservoir tank 10 by the shut-off valve 21. Then, the control unit 33 performs the adjustment control so as to adjust the relationship between the brake hydraulic pressure P and the position of the piston 25 by driving the electric cylinder 23 while the shut-off valve 21 is temporarily opened. Specifically, the control unit 33 performs the adjustment control by driving the piston 25 to the control initial position in the state where the shut-off valve 21 is opened, and then closing the shut-off valve 21. After the adjustment control, the brake fluid amounts in the electric cylinder 23, the main flow path 12A, and the wheel cylinder 11 are adjusted in the same manner as after the initialization processing such that the brake hydraulic pressure P is the atmospheric pressure when the piston 25 is located at the control initial position.

The control unit 33 performs the adjustment control when the relationship between the brake hydraulic pressure P and the position of the piston 25 deviates from the relationship set in advance. The control unit 33 performs the adjustment control when the relationship between the brake hydraulic pressure P and the position of the piston 25 is changed by the predetermined value or more before and after the operation of the electric cylinder 23. In such a case, the adjustment control is performed only when the relationship between the brake hydraulic pressure P and the position of the piston 25 is largely deviated and it is close to a state in which the braking force cannot be appropriately controlled. Therefore, it is possible to reduce the execution frequency of the adjustment control and reduce the power consumption associated with the execution of the control.

The brake pedal 19 may be operated during the execution of the adjustment control. When the brake pedal 19 is operated, the master cylinder 20 operates, and the amount of the brake fluid in the main flow path 12A changes. Therefore, when the brake pedal 19 is operated during the execution of the adjustment control, the accuracy in adjusting the relationship between the brake hydraulic pressure P and the position of the piston 25 by the adjustment control decreases. In contrast, the control unit 33 in the electric braking device according to the embodiment executes the adjustment control when the probability of operating the brake pedal 19 is lower than the predetermined threshold. More specifically, when the predetermined time TX or more elapses after the cancellation of the braking request or when the accelerator pedal is depressed, the control unit 33 determines that the probability of operating the brake pedal 19 is lower than the predetermined threshold. Therefore, the accuracy in adjusting the relationship between the brake hydraulic pressure P and the position of the piston 25 by the adjustment control is improved.

### Regarding Release Stroke SN0

In step S330 and step S340 in FIG. 9, it is determined using the release stroke SN0 whether to execute the adjustment control. The release stroke SNO corresponds to the position of the piston 25 when the brake hydraulic pressure P is reduced to the atmospheric pressure after the cancellation of the braking request.

On the other hand, as described above, the hysteresis occurs in the position of the caliper piston 14 before and after braking. Similarly, hysteresis also occurs in the position of the piston 25 of the electric cylinder 23 before and after braking. The hysteresis increases as the peak value of the brake hydraulic pressure P during braking increases. By considering such hysteresis, the determination accuracy in steps S330 and S340 can be improved. Specifically, in step S300 in FIG. 9, by setting the value of the release stroke SN0 in the following manner, the determination accuracy can be improved. In step S300, the control unit 33 calculates the hysteresis in the position of the piston 25 of the electric cylinder 23 before and after braking based on the peak value of the brake hydraulic pressure P during braking. The control unit 33 sets, as the value of the release stroke SNO, a value obtained by subtracting the hysteresis from the value of the current screw stroke SN.

### Influence of Viscosity of Brake Fluid

In the adjustment control, the relationship between the brake hydraulic pressure P and the position of the piston 25 is adjusted by driving the piston 25 in a state where the shut-off valve 21 is opened to allow the supply and discharge of the brake fluid between the main flow path 12A and the reservoir tank 10. When smoothly performing the supply and discharge of the brake fluid between the main flow path 12A and the reservoir tank 10 via the shut-off valve 21 in the adjustment control, the brake hydraulic pressure P is maintained at substantially the atmospheric pressure from the start to the end of the adjustment control. However, when the viscosity of the brake fluid is high, the brake fluid is not smoothly Supplied and discharged between the main flow path 12A and the reservoir tank 10 via the shut-off valve 21 during the adjustment control. Therefore, when the piston 25 reaches the control initial position, the brake hydraulic pressure P may deviate from the atmospheric pressure. When the adjustment control is ended by closing the shut-off valve 21 in a state where the brake hydraulic pressure P is deviated from the atmospheric pressure, the above relationship is not appropriately adjusted. Therefore, when the viscosity of the brake fluid is higher than a certain degree, it is desirable to maintain the opening of the shut-off valve 21 even after the driving of the piston 25 to the control initial value is completed. It is desirable that the time in which the shut-off valve 21 is maintained open is longer as the viscosity of the brake fluid is higher.

### Other Embodiments

The above embodiments can be modified and implemented as follows. The above embodiments and the following modifications can be implemented in combination with each other within a technically consistent range.
In the second embodiment, when the predetermined time TX or more elapses after the cancellation of the braking request or when the accelerator pedal is depressed, it is determined that the probability of operating the brake pedal 19 is lower than the predetermined threshold. The conditions for such determination may be changed as appropriate. Further, the adjustment control may be executed regardless of the probability of operating the brake pedal 19.
When the brake hydraulic pressure P is reduced to the atmospheric pressure and the shut-off state of the main flow path 12A is maintained by the shut-off valve 21, the execution of the adjustment control may be started at any timing as long as the adjustment control and the retraction control are executed in this order.
In step S330 in FIG. 9, when the release stroke SN0 is less than the predetermined value S1 or exceeds the predetermined value S2, it is determined that the relationship between the brake hydraulic pressure P and the position of the piston 25 deviates from the relationship set in advance. In addition, in step S340 in FIG. 9, it is determined whether the change width (=SNZ−SN0) of the value of the release stroke SNO between the previous braking and the current braking is equal to or greater than the predetermined value SX. Accordingly, it is determined whether the relationship between the brake hydraulic pressure P and the position of the piston 25 is changed by the predetermined value or more before and after the operation of the electric cylinder 23. These determinations may be performed in a mode other than the above.
In the second embodiment, the adjustment control is executed when the relationship between the brake hydraulic pressure P and the position of the piston 25 deviates from the relationship set in advance, or when the relationship is changed by the predetermined value or more before and after the operation of the electric cylinder 23. The adjustment control may be executed only in one of these cases. Further, the adjustment control may be executed regardless of these cases.
The electric braking device according to the second embodiment may not execute the retraction control.
In the above embodiments, the backward drive of the actuator 27 of the electric cylinder 23 when the braking request is canceled is stopped in the case where the brake hydraulic pressure P decreases to the atmospheric pressure. A stop timing of the backward drive at this time may be determined based on a parameter other than the brake hydraulic pressure P. Examples of the parameter other than the brake hydraulic pressure P include an advance amount of the piston 25 of the electric cylinder 23. For example, when the braking request is canceled, the control unit 33 may perform the backward drive of the actuator 27 until the advance amount of the piston 25 from the position at the start of braking is 0. The advance amount of the piston 25 is obtained by installing, in the electric cylinder 23, a position sensor configured to measure the position of the piston 25 in the cylinder 24 or performing calculation from the drive amount of the actuator 27 after the start of braking.
In the above embodiments, the control unit 33 commands the forward drive of the actuator 27 by the retraction amount in the previous retraction control prior to the start of braking, but may not execute the command.
In the above embodiments, the retraction amount in the retraction control is determined based on the peak value of the brake hydraulic pressure P in the wheel cylinder 11 increased by the electric cylinder 23 during the last braking force generation. The retraction amount may be determined based on a parameter other than the peak value or may be a fixed value. Examples of the parameter other than the peak value of the brake hydraulic pressure P in the wheel cylinder 11 include an advance amount of the wheel cylinder 11. The advance amount of the wheel cylinder 11 is obtained by installing, in the wheel cylinder 11, a position sensor configured to measure the position of the caliper piston 14 or installing a flow velocity meter in the main flow path 12A and performing estimation from a measured value of the flow velocity.
In the braking control routine in FIG. 2, the peak value is reset to 0 in step S210. The timing of resetting the peak value to 0 is not limited to step S210. For example, the peak value may be reset in response to a trigger based on an estimation that the position of the caliper piston 14 is restored. Examples of the trigger include rotation of a tire and generation of a lateral force in the tire. Since the brake rotor 18 does not accurately have a uniform surface, the caliper piston 14 is pushed back via the friction material 16 when the brake rotor 18 rotates. Therefore, it can be estimated that the position of the caliper piston 14 is restored when the tire rotates.
Although the drive speed of the actuator 27 in the backward direction R in the retraction control is fixed in the above embodiments, the drive speed may be variable. Also in this case, it is desirable to limit the drive speed to a certain speed or less so that the operation sound of the actuator 27 remains at a magnitude that does not cause the occupant to feel uncomfortable.
After the end of braking, the shut-off valve 21 may be temporarily opened before the retraction control is started. Also in this case, the responsiveness at the start of braking can be ensured by causing the electric cylinder 23 to stand by with the shut-off valve 21 closed and maintaining the shut-off valve 21 closed until the end of braking.
The retraction control may not be performed after the end of braking.
The control unit 33 may be implemented as a circuit including one or more processors that operate in accordance with a computer program, one or more dedicated hardware circuits such as dedicated hardware that performs some processing of various types of processing, or a combination thereof. Examples of the dedicated hardware include an ASIC that is an application-specific integrated circuit. The processor includes a CPU and a memory, such as a RAM and a ROM, and the memory stores program codes or commands configured to cause the CPU to perform processing. The memory, that is, a storage medium includes any available medium that can be accessed by a general-purpose or dedicated computer.

### SUPPLEMENTARY NOTES

[Supplementary Note 1] The electric braking device according to claim 2 or 3, in which the control unit sets a drive amount of the electric cylinder in a direction, in which the brake fluid is suctioned from the main flow path in the retraction control, to be larger when a peak value of the brake hydraulic pressure during last braking is large than when the peak value is small.

[Supplementary Note 2] The electric braking device according to any one of claims 2 to 4 and the supplementary note 1, in which the electric cylinder includes a linear motion conversion mechanism configured to convert rotation of a rotary member by the actuator into a linear motion of a linear motion member, a piston configured to linearly move in a cylinder according to the linear motion of the linear motion member, and a fluid chamber partitioned by the cylinder and the piston, and the electric cylinder is configured to generate a hydraulic pressure by pressing the brake fluid introduced into the fluid chamber according to the linear motion of the piston.

1. An electric braking device comprising:
a shut-off valve provided in a connection path connecting a reservoir tank and a wheel cylinder, and configured to switch the connection path between a communication state and a shut-off state; and
an electric cylinder connected to a main flow path that is a portion of the connection path between the shut-off valve and the wheel cylinder, and configured to discharge a brake fluid to the main flow path and suction the brake fluid from the main flow path by linearly moving a piston in the cylinder in response to driving by an electric motor, wherein
a brake hydraulic pressure is generated in the wheel cylinder by discharging the brake fluid to the main flow path by the electric cylinder in a shut-off state of the main flow path by the shut-off valve, and
the electric braking device comprises a control unit configured to maintain the shut-off state of the main flow path by the shut-off valve even after the brake hydraulic pressure generated in the wheel cylinder decreases to an atmospheric pressure due to suction of the brake fluid from the main flow path by the electric cylinder.

2. The electric braking device according to claim 1, wherein
the control unit executes retraction control for driving the electric cylinder in a direction in which the brake fluid is suctioned from the main flow path in a state where the brake hydraulic pressure generated in the wheel cylinder is reduced to the atmospheric pressure and the shut-off state of the main flow path by the shut-off valve is maintained.

3. The electric braking device according to claim 2, wherein
in the retraction control, the control unit changes a drive amount of the electric cylinder in the direction in which the brake fluid is suctioned from the main flow path according to the brake hydraulic pressure in the wheel cylinder increased by the electric cylinder.

4. The electric braking device according to claim 1, wherein
the control unit performs adjustment control for adjusting a relationship between the brake hydraulic pressure and a position of the piston by temporarily opening the shut-off valve and driving the electric cylinder from a state where the brake hydraulic pressure generated in the wheel cylinder is reduced to the atmospheric pressure and the main flow path is shut off by the shut-off valve.

5. The electric braking device according to claim 4, wherein
the control unit performs the adjustment control when the relationship between the brake hydraulic pressure and the position of the piston deviates from a relationship set in advance.

6. The electric braking device according to claim 4, wherein
the control unit performs the adjustment control when the relationship between the brake hydraulic pressure and the position of the piston is changed by a predetermined value or more before and after operation of the electric cylinder.

7. The electric braking device according claim 6, further comprising:
a master cylinder provided in a portion of the connection path between the reservoir tank and the shut-off valve and configured to supply and discharge the brake fluid in response to an operation of an operation member, wherein
the control unit executes the adjustment control when a probability of operating the operation member is lower than a predetermined threshold.

8. The electric braking device according to claim 5, further comprising:
a master cylinder provided in a portion of the connection path between the reservoir tank and the shut-off valve and configured to supply and discharge the brake fluid in
the control unit executes the adjustment control when a probability of operating the operation member is lower than a predetermined threshold.

9. The electric braking device according to claim 4, further comprising:
a master cylinder provided in a portion of the connection path between the reservoir tank and the shut-off valve and configured to supply and discharge the brake fluid in response to an operation of an operation member, wherein
the control unit executes the adjustment control when a probability of operating the operation member is lower than a predetermined threshold.
